(19) United States
(12) Patent Application Publication
(10) Pub. No.: US 2013/0147408 A1
(43) Pub. Date: Jun. 13, 2013

(54) MOTOR CURRENT PHASE DETECTING DEVICE AND MOTOR DRIVE DEVICE HAVING SAME

(71) Applicants: Kenji Sugiura, Osaka (JP); Masahiro Yasohara, Hyogo (JP)

(72) Inventors: Kenji Sugiura, Osaka (JP); Masahiro Yasohara, Hyogo (JP)

(73) Assignee: PANASONIC CORPORATION, Kadoma-shi, Osaka (JP)

(21) Appl. No.: 13/818,605

(22) PCT Filed: Sep. 6, 2011
(86) PCT No.: PCT/JP2011/004975

§ 371 Date: Feb. 22, 2013

(30) Foreign Application Priority Data
Sep. 15, 2010 (JP) 2010-206303

(51) Int. Cl. H02P 6/00

(52) U.S. Cl. CPC H02P 6/002
USPC 318/400.23

(57) ABSTRACT

The present invention is directed to a motor current phase detecting device that drives a motor having a three-phase drive coil, the device including a power distributor that supplies a drive voltage and a drive current to the drive coil, a current detector that detects a common current waveform flowing from the power distributor, a position detector that detects a position of a rotor, a waveform generator that generates a first PWM signal, a waveform regulator that generates a second PWM signal based on the first PWM signal, and a current phase detector that detects a phase of a drive current flowing in each of the drive coil. The waveform regulator generates the second PWM signal that operates a current phase detector while maintaining a relative voltage value between the drive coils determined by the first PWM signal, and the current phase detector detects the phase of the drive current of the drive coil by detecting a peak current value of the drive coil included in the common current waveform based on the second PWM signal.

### TECHNICAL FIELD

The present invention relates to a phase detecting device of coil current used when a brushless DC motor and the like used in, for example, an air-conditioner, a water heater having a combustion fan motor, an air purifier, and an information technology device such as a copying machine and a printer are driven, and a motor drive device having same.

### BACKGROUND ART

As a conventional drive scheme of a brushless DC motor (to be referred to as a “motor” hereinafter), a rectangular wave drive scheme that drives a drive voltage supplied to a drive coil of the motor with a rectangular waveform has been popularly employed.

However, in recent years, demand for a motor driven with a less torque ripple, less noise, and less vibration has increased. As a drive technique corresponding to the demand, a sinusoidal-wave drive scheme that drives a drive voltage supplied to a drive coil of a motor with an almost sinusoidal waveform has been commonly used.

As a conventional technique that drives a motor by the sinusoidal-wave drive scheme, sinusoidal waveform data stored in a memory depending on rotational positions of a motor are sequentially read. The read waveform data are subjected to pulse width modulation (PWM: Pulse Width Modulation). Switching elements constituting a power distributor that supplies electric power to the drive coil of the motor are controlled by PWM to sinusoidal-wave-drive the motor (refer to PTL 1, for example).

A conventional motor drive device will be described below with reference to FIG. 7.

FIG. 7 is a circuit diagram of a conventional motor drive device.

As shown in FIG. 7, motor drive device 100 includes at least a motor, DC power supply 141, power distributor 150, waveform generator 180, and position detector 190. The motor has rotor 121 and three-phase drive coils 101, 103, and 105. Power distributor 150 includes a plurality of switching elements. Drive coils 101, 103, and 105 of the motor are supplied with a drive voltage and a drive current from DC power supply 141 through power distributor 150 including a plurality of switching elements. Waveform generator 180 generates a signal for on/off-controlling each of the switching elements of power distributor 150. Position detecting element 131 and position detector 190 detect position information of rotor 121 of the motor.

A circuit operation of conventional motor drive device 100 will be described below in detail.

The position information of rotor 121 of the motor is detected by a plurality of position detecting elements 131 configured by hall elements and the like and position detector 190. Detected position information Hu of rotor 121 is outputted from position detector 190 and inputted to waveform generator 180. In accordance with position information Hu of rotor 121, waveform generator 180 outputs, to power distributor 150, PWM signals UH0, VH0, WH0, UL0, VL0, and WL0 that are set in advance such that voltage differences between the drive coils are almost sinusoidal waves.

Switching elements 151, 152, 153, 154, 155, and 156 in power distributor 150 are on/off-controlled by PWM signals UH0, VH0, WH0, UL0, VL0, and WL0 outputted from waveform generator 180. In this manner, drive voltages Vu, Vv, and Vw and drive currents Iu, Iv, and Iw are supplied from DC power supply 141 to drive coils 101, 103, and 105. At this time, common current Idc flowing from power distributor 150 to DC power supply 141 is detected with current detector 161 including, for example, a resistor or the like. Common current Idc detected with current detector 161 is used when designation is performed such that waveform generator 180 outputs (not shown) a signal that turns off all the switching elements of power distributor 150, for example, when common current Idc excessively increases to control the motor.

However, conventional motor drive device 100, as will be described below, has a problem in which a motor cannot be efficiently driven.

More specifically, in order to efficiently drive the motor, a phase of a drive current flowing in the drive coil of the motor and a phase of an induced voltage induced to the drive coil of the motor must be caused to coincide with each other. At this time, the drive current flowing in the drive coil of the motor has a value obtained by dividing a voltage obtained by subtracting the induced voltage from a drive voltage applied to the drive coil by an impedance of the drive coil. For this reason, the phase of the drive current flowing in the drive coil of the motor always changes depending on a rotating speed of the motor and magnitudes of the drive current and the drive voltage with respect to rotor 121 of the motor.

However, conventional motor drive device 100 does not have a configuration that obtains information of the phase of the drive current flowing in the drive coil of the motor. Thus, a drive voltage waveform to the position of rotor 121 of the motor is uniquely determined. For this reason, the motor cannot be efficiently driven by causing the phase of the drive current that always changes and flows in the drive coil of the motor and the phase of the induced voltage induced to the drive coil of the motor to coincide with each other.

PLT 1: Japanese Patent No. 3232467

### SUMMARY OF THE INVENTION

The present invention is directed to a motor current phase detecting device that drives a motor having drive coils, the device including a power distributor that supplies a drive voltage and a drive current to each of the drive coils, a current detector that detects a common current waveform flowing from the power distributor, a position detector that detects a position of a rotor, a waveform generator that generates a first PWM signal, a waveform regulator that generates a second PWM signal based on the first PWM signal, and a current phase detector that detects a phase of a drive current flowing in each of the drive coils. The waveform regulator generates the second PWM signal that operates a current phase detector while maintaining a relative voltage value between the drive coils determined by the first PWM signal, and the current phase detector detects the phase of the drive current of the drive coil by detecting a peak current value of the drive coil included in the common current waveform based on the second PWM signal.

In this manner, the phase of the drive current flowing in the drive coil of the motor can be detected with a simple configuration. As a result, the motor can be efficiently driven by causing the phase of the drive current flowing in the drive coil of the motor and the phase of the induced voltage induced to the drive coil of the motor to coincide with each other.

### BRIEF DESCRIPTION OF THE DRAWINGS

FIG. 1 is a block diagram of a motor drive device including a motor current phase detecting device according to an exemplary embodiment of the present invention.

FIG. 2 is a diagram for explaining waveforms generated by a waveform generator of the motor current phase detecting device according to the exemplary embodiment.

FIG. 3 is a diagram showing relationships between a drive current, a drive voltage, and a waveform of a common current flowing in a drive coil of a motor according to the exemplary embodiment.

FIG. 4 is a diagram showing relationships between a drive voltage, a common current waveform, and phase information in the motor current phase detecting device according to the exemplary embodiment.

FIG. 5 is a diagram for explaining a relationship between a first PWM signal of the motor current phase detecting device and a second PWM signal regulated with a waveform regulator according to the exemplary embodiment.

FIG. 6 is a diagram showing relationships between a motor drive voltage, a common current waveform, and phase information obtained after regulation by the waveform regulator of the motor current phase detecting device according to the according to the exemplary embodiment.

FIG. 7 is a circuit diagram of a conventional motor drive device.

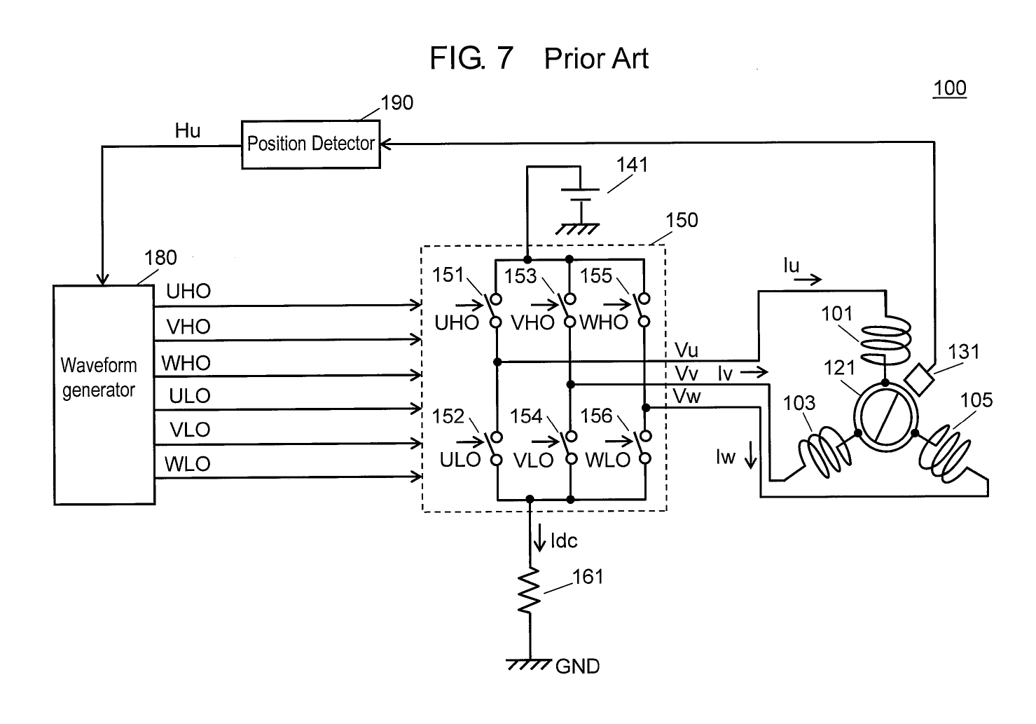

### DETAILED DESCRIPTION OF THE PREFERRED EMBODIMENTS

A motor current phase detecting device according to an exemplary embodiment of the present invention will be described below with reference to the accompanying drawings. The present invention is not limited to the embodiment.

### Embodiment

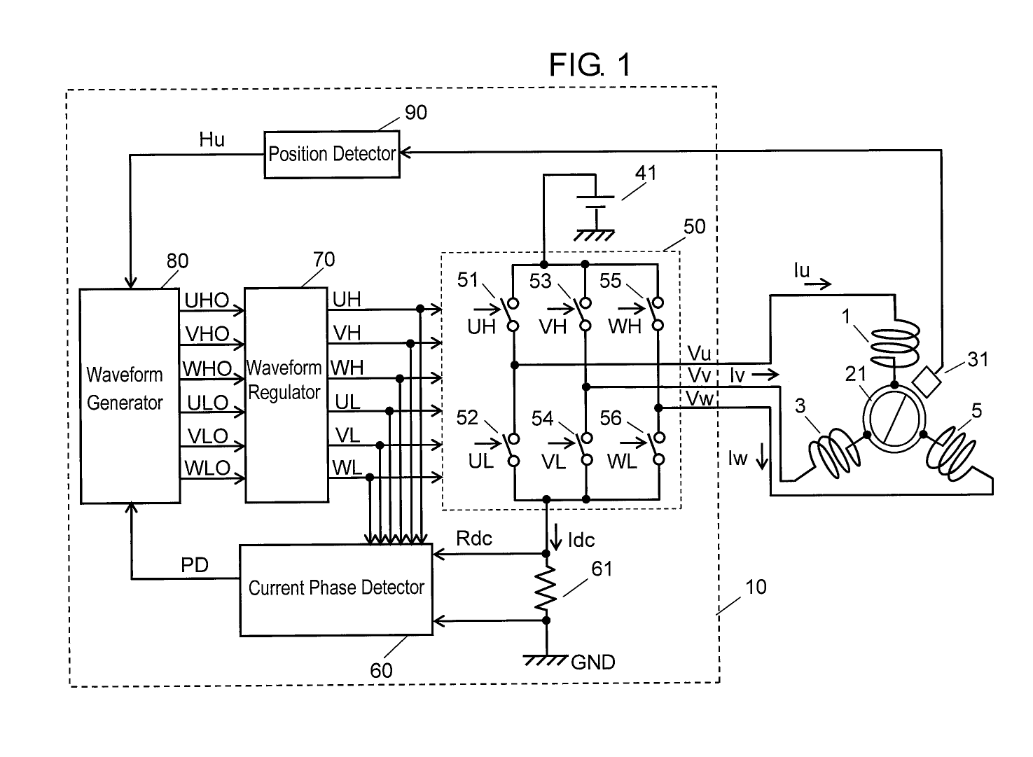

FIG. 1 is a block diagram of a motor drive device including a motor current phase detecting device according to an exemplary embodiment of the present invention.

As shown in FIG. 1, a motor drive device includes at least a motor and motor current phase detecting device 10. Motor current phase detecting device 10 includes at least DC power supply 41, power distributor 50, current phase detector 60, waveform regulator 70, waveform generator 80, and position detector 90. The motor has rotor 21 and drive coils 1, 3, and 5 of three-phases including a U phase, a V phase, and a W phase. Power distributor 50 includes a plurality of switching elements 51, 52, 53, 54, 55, and 56. Drive coils 1, 3, and 5 of the motor are supplied with a drive voltage and a drive current from DC power supply 41 through power distributor 50 including the plurality of switching elements 51, 52, 53, 54, 55, and 56. Waveform generator 80 generates a first PWM signal inputted to waveform regulator 70 and on which switching elements 51, 52, 53, 54, 55, and 56 of power distributor 50 are on/off-controlled based. Waveform regulator 70 regulates a pulse width and a generation timing based on the first PWM signal inputted from waveform generator 80 to generate a second PWM signal, and on/off-controls switching elements 51, 52, 53, 54, 55, and 56 of power distributor 50. Position detecting element 31 and position detector 90 detect position information Hu of rotor 21 of the motor and outputs the information to waveform generator 80.

A circuit configuration of a motor drive device including the motor current phase detecting device according to the exemplary embodiment of the present invention will be described below.

A position of rotor 21 of the motor is detected by a plurality of position detecting elements 31 including, for example, hall elements or the like. The detected position of rotor 21 is outputted from position detecting elements 31 to position detector 90 and inputted to waveform generator 80 as position information Hu. In accordance with position information Hu of rotor 21, waveform generator 80 outputs, to waveform regulator 70, first PWM signals UH0, VH0, WH0, UL0, VL0, and WL0 that are set in advance such that voltage differences between drive coils are almost sinusoidal waves (including sinusoidal waves).

Waveform regulator 70 regulates pulse widths and generation timings of first PWM signals UH0, VH0, WH0, UL0, VL0, and WL0 inputted from waveform generator 80 while maintaining relative voltage values between the drive coils (U phase-V phase, V phase-W phase, and W phase-U phase) to output second PWM signals UH, VH, WH, UL, VL, and WL. Second PWM signals UH, VH, WH, UL, VL, and WL regulated with waveform regulator 70 are outputted to power distributor 50 and current phase detector 60.

Switching elements 51, 52, 53, 54, 55, and 56 in power distributor 50 are on/off-controlled with second PWM signals UH, VH, WH, UL, VL, and WL outputted from waveform regulator 70. In this manner, drive voltages Vu, Vv, and Vw and drive currents Iu, Iv, and Iw are supplied from DC power supply 41 to drive coils 1, 3, and 5 through power distributor 50, respectively. At this time, common current Idc flowing from power distributor 50 to DC power supply 41 is detected with current detector 61 including, for example, a resistor or the like. Detected common current Idc is inputted to current phase detector 60 as common current waveform Rdc.

Current phase detector 60 detects phases of drive currents Iu, Iv, and Iw flowing in drive coils 1, 3, and 5 based on common current waveform Rdc inputted from current detector 61 and second PWM signals UH, VH, WH, UL, VL, and WL inputted from waveform regulator 70. Current phase detector 60 outputs phase information PD of detected drive currents Iu, Iv, and Iw of drive coils 1, 3, and 5 to waveform generator 80.

Waveform generator 80 controls the first PWM signals based on phase information PD inputted from current phase detector 60 and position information Hu inputted from position detector 90. The phase of the drive current flowing in the drive coil of the motor and the phase of the induced voltage induced by the drive coil of the motor are caused to coincide with each other based on the second PWM signal obtained by regulating the first PWM signal with waveform regulator 70 so as to drive the motor.

As described above, the motor drive device including the motor current phase detecting device according to the exemplary embodiment of the present invention is configured.

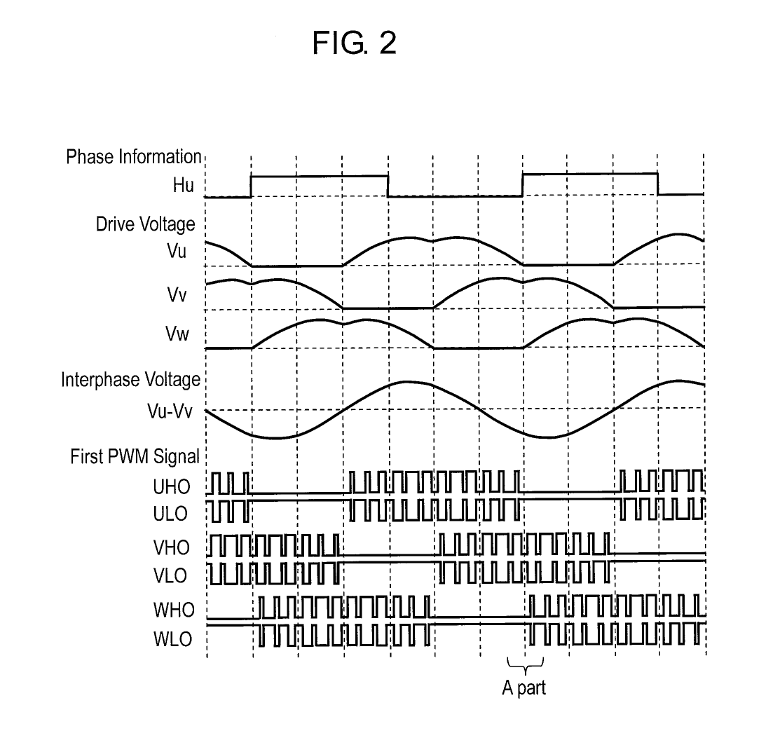

An operation of the motor current phase detecting device configured as described above will be described below with reference to FIG. 2 to FIG. 6.

FIG. 2 is a diagram for explaining waveforms generated by the waveform generator of the motor current phase detecting device according to the exemplary embodiment of the present invention.

That is, FIG. 2 shows relationships between position information Hu of rotor 21 of the motor detected by position detector 90 and first PWM signals UH0, VH0, WH0, UL0, VL0, and WL0 outputted by waveform generator 80.

As shown in FIG. 2, waveforms of a U voltage, a V voltage, and a W voltage are pieces of waveform information of voltages serving as sources that generate the first PWM signals. At this time, voltage differences between phases (U phase-V phase, V phase-W phase, and W phase-U phase) of the U voltage, the V voltage, and the W voltage are almost sinusoidal waveforms (including sinusoidal waves) as shown by, for example, the waveform of an inter-U-V voltage in FIG. 2. Similarly, although not shown in FIG. 2, an inter V-W voltage and an inter-W-U voltage also have almost sinusoidal waveforms (including sinusoidal waves). At this time, the first PWM signals are generated by, for example, triangular wave comparison or the like based on the pieces of waveform information of the U voltage, the V voltage, and the W voltage.

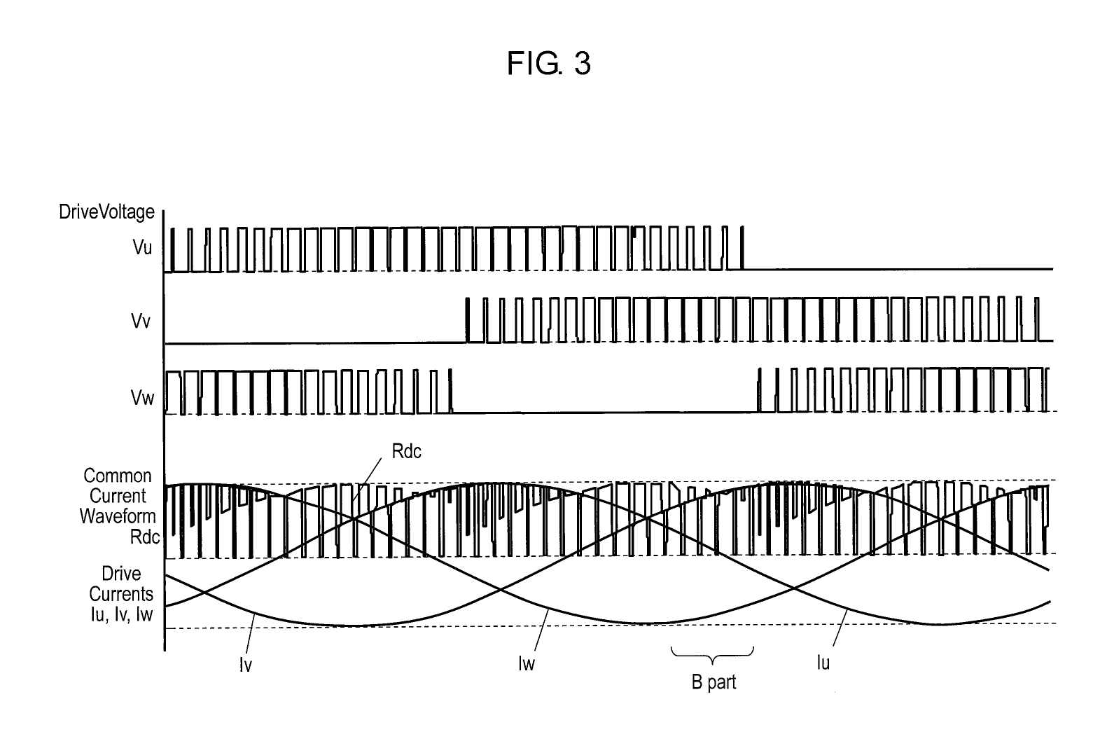

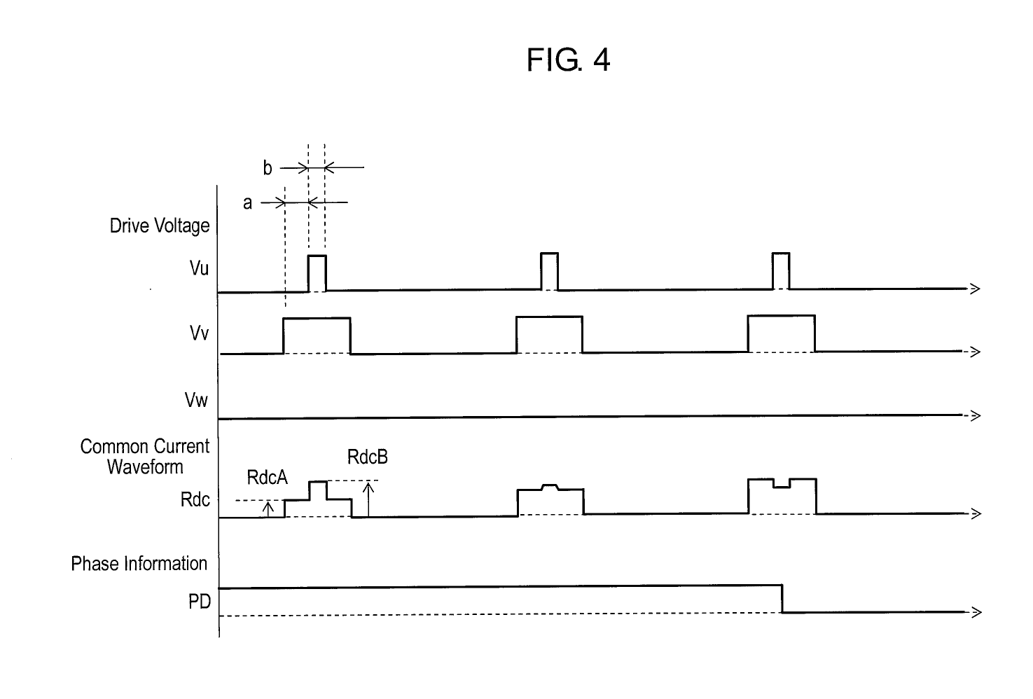

Phase detection of the motor current phase detecting device according to the exemplary embodiment of the present invention will be described below with reference to FIG. 3 and FIG. 4.

FIG. 3 is a diagram showing relationships between a drive current, a drive voltage, and a waveform of a common current flowing in a drive coil of a motor according to the exemplary embodiment.

The following explanation is made on the assumption that the switching element is turned on when pulse waveforms of the first PWM signal and the second PWM signal are High and the switching element is turned off when the pulse waveforms are Low.

That is, FIG. 3 shows relationships between drive voltages Vu, Vv, and Vw of drive coils 1, 3, and 5 of the motor, common current waveform Rdc, and drive currents Iu, Iv, and Iw of drive coils 1, 3, and 5. At this time, drive voltages Vu, Vv, and Vw applied to drive coils 1, 3, and 5 of the motor are outputted under the control of the switching elements of power distributor 50 by the second PWM signal. More specifically, when second PWM signals UH, VH, and WH that control switching elements 51, 53, and 55 above power distributor 50 are in an ON state, drive voltages Vu, Vv, and Vw of drive coils 1, 3, and 5 of the motor go to High. On the other hand, when second PWM signals UL, VL, and WL that control switching elements 52, 54, and 56 below power distributor 50 are in an ON state, drive voltages Vu, Vv, and Vw of drive coils 1, 3, and 5 of the motor go to Low.

When drive voltages Vu, Vv, and Vw of drive coils 1, 3, and 5 of the motor have waveforms as shown in FIG. 3, common current waveform Rdc is detected as waveforms including waveform information of drive currents Iu, Iv, and Iw as shown in FIG. 3. At this time, waveforms of drive currents Iu, Iv, and Iw on the negative side are waveforms that are folded at a zero level, are waveforms obtained by superposing the waveforms, and are detected as common current waveforms Rdc.

Thus, common current waveform Rdc including the pieces of waveform information of drive currents Iu, Iv, and Iw will be described below with reference to FIG. 4.

FIG. 4 is a diagram showing relationships between a drive voltage, a common current waveform, and phase information in the motor current phase detecting device according to the exemplary embodiment. FIG. 4 shows a B part shown in FIG. 3 as a typically enlarged diagram.

That is, as shown in FIG. 4, in section a, switching element 53 above only the V phase of power distributor 50 is turned on, and upper switching elements 51 and 55 are in an OFF state. For this reason, in common current waveform Rdc, a peak current value of drive current Iv flowing in V-phase drive coil 3 is detected as RdcA. At this time, switching element 54 below the V phase of power distributor 50 is turned off, and switching element 52 and 56 below the other phases are turned on.

In section b, switching element 56 below only the W phase of power distributor 50 is turned on, and switching elements 52 and 54 below the other phases are turned off. For this reason, in common current waveform Rdc, as RdcA, the peak current value of drive current Iw flowing in W-phase drive coil 5 is detected as a waveform the polarity of which is inverted. This is because a flowing direction of drive current Iw is opposite to the arrow in the drawing. At this time, switching element 55 above the W phase of power distributor 50 is turned off, and switching element 51 and 53 above the other phases are turned on.

Thus, it is understood that common current waveform Rdc includes pieces of information of drive currents Iv and Iw of two phases, i.e., a V phase and a W phase as peak current values.

In this case, in a motor having three-phase drive coils, a total of drive currents Iu, Iv, and Iw flowing in three-phase drive coils 1, 3, and 5 is zero. For this reason, as described above, when pieces of information of drive currents of two phases, for example, the V phase and the W phase can be obtained, a drive current of the U phase serving as one remaining phase can be easily estimated.

Thus, by using common current waveform Rdc detected with current detector 61, current phase detector 60 can generate phase information PD of a drive current of a drive coil.

Phase information PD of the drive current of the drive coil generated by current phase detector 60 will be concretely described below.

Current phase detector 60 detect, for example, section a or section b in FIG. 4 by using second PWM signals UK VH, WH, UL, VL, and WL outputted from waveform regulator 70. At this time, for example, pieces of magnitude information of RdcA and RdcB are obtained from the peak current value of common current waveform Rdc corresponding to section a or section b.

As shown in FIG. 4, based on a position where a relationship between magnitudes of RdcA that is the peak current value of drive current Iv of drive coil 3 and RdcB that is the peak current value of drive current Iw of drive coil 5 is inverted, as indicated by a B part in FIG. 3, a position where the polarity of drive current Iu of the remaining phase (in this case, the U phase) is inverted can be detected. In this manner, the phase information of the drive current can be obtained from the peak current value of common current waveform Rdc.

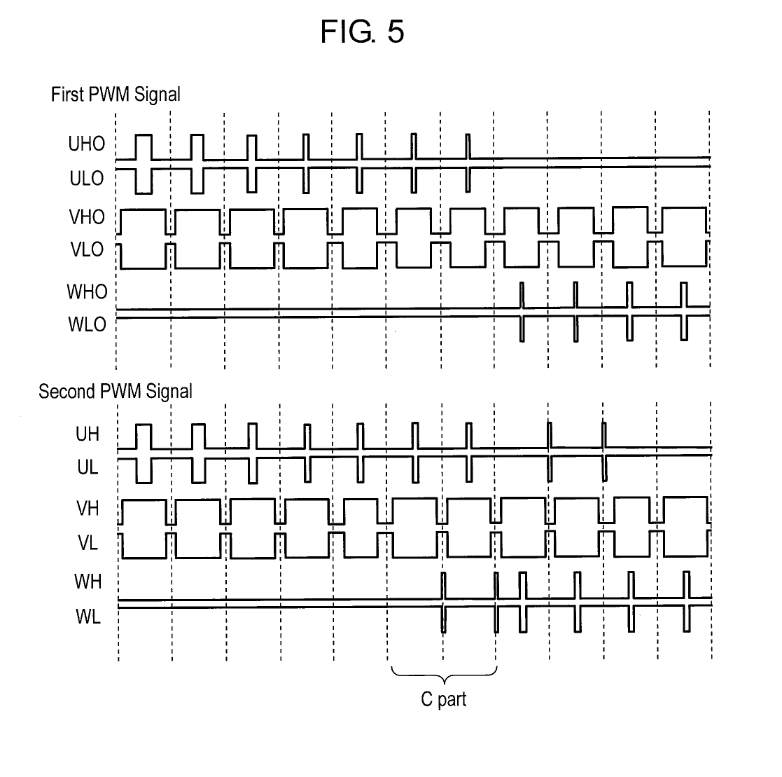

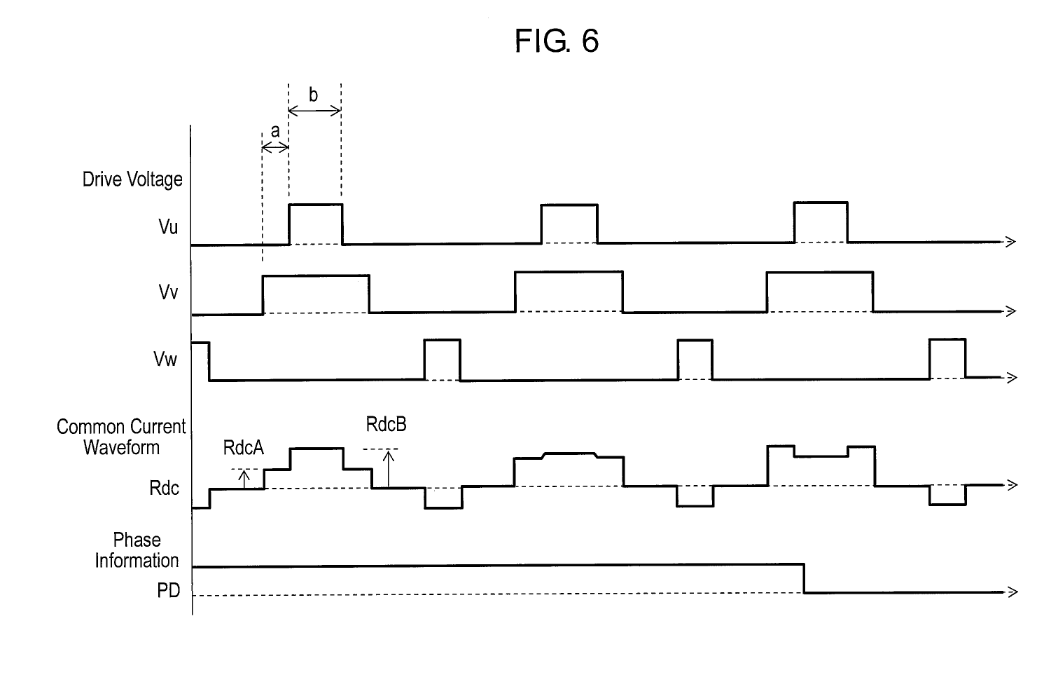

Based on the first PWM signal of waveform generator 80, waveform regulator 70 that regulates a pulse width and a generation timing to generate a second PWM signal will be described below with reference to FIG. 5 and FIG. 6.

FIG. 5 is a diagram for explaining a relationship between the first PWM signal of the motor current phase detecting device and the second PWM signal regulated with a waveform regulator according to the embodiment. The first PWM signal shown in an upper half of FIG. 5 is shown in a typically enlarged diagram of an A part of the first PWM signal shown in FIG. 2.

At this time, as shown in FIG. 2, in an A part, pulse widths of first PWM signals UH0 and WH0 outputted from waveform generator 80 become relatively narrow.

However, when magnitude information of common current waveform Rdc is detected, the pulse width of the first PWM signal is preferably wide. This is because, since the pulse width of the first PWM signal becomes narrow near a zero level of the first PWM signal, a change in peak current value of common current waveform Rdc may not be able to be detected at a normal timing. Furthermore, for example, response of the switching element of power distributor 50 configured by a MOS (Metal Oxide Semiconductor) or the like is too late, and common current waveform Rdc may not be outputted.

Waveform regulator 70 regulates the pulse widths and the generation timings of first PWM signals UH0, UH0, WH0, UL0, VL0, and WL0 inputted from waveform generator 80 and being in a narrow-pulse-width section. More specifically, as shown by the second PWM signals in the lower half of FIG. 5, the generation timings of the pulses are regulated by an increase in pulse width or time shifting. At this time, waveform regulator 70 regulates the pulse widths and the generation timing of the pulse while maintaining relative voltage values between the drive coils. More specifically, the first PWM signal inputted from waveform generator 80 generates second PWM signals UH, VH, WH, UL, VL, and WL regulated by widening, for example, parts having narrow pulse widths as needed.

A method of detecting phase information by using a drive voltage outputted from power distributor 50 by the second PWM signals regulated with waveform regulator 70 will be described below with reference to FIG. 6 in addition to FIG. 5.

FIG. 6 is a diagram showing relationships between a motor drive voltage, a common current waveform, and phase information obtained after regulation by the waveform regulator of the motor current phase detecting device according to the exemplary embodiment. FIG. 6 shows a C part shown in FIG. 5 as a typically enlarged diagram.

As shown in FIG. 6, waveform regulator 70 outputs second PWM signal UH by widening the pulse width of first PWM signal UH0. At this time, by the increase in pulse width of first PWM signal UH0, an average voltage of drive voltage Vu of U-phase drive coil 1 becomes up (high). In order to maintain a relative voltage value between the drive coils, waveform regulator 70 regulates the second PWM signal such that the pulse width of drive voltage Vv of V-phase drive coil 3 is similarly widened. Furthermore, in order to similarly up an average voltage, drive voltage Vw of W-phase drive coil 5 is regulated to generate a second PWM signal having a High section. At this time, a section in which W-phase drive voltage Vw is High has a timing different from a timing of a section in which V-phase drive voltage Vv and U-phase drive voltage Vu are generated, the W-phase drive voltage Vw is generated in a section except for a section in which current phase detector 60 detects common current waveform Rdc. This is because, when the pulse width of the U-phase second PWM signal is increased, at the same time, a pulse of the second PWM signal is also generated in the W phase. For this reason, the peak current value of common current waveform Rdc includes three-phase information. As a result, phase information PD cannot be detected. More specifically, the generation timing of the pulse of W-phase drive voltage Vw is changed to hold the relative voltage values between the drive coils constant and to make it possible to detect phase information PD without affecting magnitude information (peak current value) of common current waveform Rdc detected by current phase detector 60.

Current phase detector 60 generates, based on the regulated second PWM signal, phase information PD of the drive current of the drive coil by pieces of magnitude information of RdcA and RdcB that are peak current values of the drive currents of the drive coils detected from common current waveform Rdc. Generated phase information PD of the drive currents of the drive coils is inputted to waveform generator 80.

Waveform generator 80 regulates phases to obtain a drive voltage waveform that causes a phase of a drive current flowing in the drive coil to coincide with a phase of an induced voltage induced in the drive coil based on inputted phase information PD and position information Hu of the rotor of the motor to output a first PWM signal. In this case, the phase information of the induced voltage is detected based on position information Hu of the rotor.

The pulse width and the generation timing of the first PWM signal outputted from waveform generator 80 are regulated with waveform regulator 70 to generate a second PWM signal, and the motor is driven through power distributor 50.

According to the exemplary embodiment, the phase information of the drive current can be detected in a simple circuit configuration in which the phase information of the drive current is detected by a current phase detector from the peak current value of common current waveform Rdc detected by the current detector. In this manner, the motor can be driven such that the phase of the drive current flowing in the drive coil of the motor and the phase of the induced voltage induced by the drive coil are caused to coincide with each other. As a result, a motor drive device that can efficiently drive the motor and drives the motor with small noise and small vibration can be realized.

According to the exemplary embodiment, the waveform regulator is arranged to prevent a detection mistake occurring when a pulse width is narrow or an output mistake caused by a response speed of a switching element so as to make it possible to reliably detect phase information. As a result, a high-efficiency motor drive device having high controllability and high reliability can be realized.

The motor current phase detecting device according to the exemplary embodiment is combined to a motor to make it possible to realize a motor drive device that can efficiently drive the motor with small noise and small vibration.

### INDUSTRIAL APPLICABILITY

The present invention is useful for fan drive of a motor for air-conditioning equipment required to be efficiently driven with small vibration and low noise or drive of a motor used in a home electric appliance such as an air purifier, a refrigerator, a washing machine, a water heater having a combustion fan motor; or a printer, a copying machine, scanner, a facsimile, or a complex machine thereof; or an information technology device such as a hard disk drive or an optical medium device.

### REFERENCE NUMERALS IN THE DRAWINGS

1, 3, 5, 101, 103, 105 drive coil

10, motor current phase detecting device

21, 121 rotor

31, 131 position detecting element

41, 141 DC power supply

50, 150 power distributor

51, 52, 53, 54, 55, 56, 151, 153, 155, 152, 154, 156 switching element

60 current phase detector

61, 161 current detector

70 waveform regulator

80, 180 waveform generator

90, 190 position detector

100 motor drive device

1. A motor current phase detecting device that drives a motor having a rotor and three-phase drive coils, the device comprising:
a power distributor that supplies a drive voltage and a drive current to each of the drive coils;
a current detector that detects a common current waveform flowing from the power distributor;
a position detector that detects a position of the rotor;
a waveform generator that generates a first PWM signal;
a waveform regulator that generates a second PWM signal based on the first PWM signal; and
a current phase detector that detects a phase of the drive current flowing in each of the drive coils,
wherein the waveform regulator generates the second PWM signal that operates the current phase detector while maintaining a relative voltage value between the drive coils determined by the first PWM signal, and the current phase detector detects the phase of the drive current of the drive coil by detecting a peak current value of the drive coil included in the common current waveform based on the second PWM signal.

2. The motor current phase detecting device according to claim 1,
wherein the second PWM signal is generated such that a pulse width and a generation timing are regulated based on the first PWM signal.

3. The motor drive device comprising:
a motor having a rotor and three-phase drive coils; and
a motor current phase detecting device according to claim 1.

4. The motor drive device comprising:
a motor having a rotor and three-phase drive coils; and
a motor current phase detecting device according to claim 2.
